(19) United States
(12) Patent Application Publication
(10) Pub. No.: US 2009/0230157 A1
(43) Pub. Date: Sep. 17, 2009

(54) POURING STOPPER

(75) Inventor: Peter Lindberg, Greve (DK)

Correspondence Address: CANTOR COLBURN, LLP, 20 Church Street, 22nd Floor, Hartford, CT, 06103, US

(73) Assignee: WIRCON A/S, GREVE (DK)

(21) Appl. No.: 12/305,171

(22) PCT Filed: Jun. 15, 2007
(86) PCT No.: PCT/DK07/00292

§ 371 Date: Feb. 20, 2009

(30) Foreign Application Priority Data
Jun. 16, 2006 (DK) PA 2006 00814
Dec. 1, 2006 (DK) PA 2006 01591

(51) Int. Cl. B67D 3/00

(52) U.S. Cl. 222/504

(57) ABSTRACT

A pouring stopper to be mounted on a bottle has an inlet gasket, an outlet gasket and an air admission valve. The mentioned gaskets are controlled by a magnetizable rod, which, together with a coil, is incorporated in an area, such as a liquid chamber, in the pouring stopper. Another housing contains a battery and electronics. With the pouring stopper according to the invention, a very compact pouring stopper is achieved, which may be used both handheld and in a bottle holder. Further, it is possible to dose on the basis of a volume or on the basis of a time interval. Finally, it is possible to monitor the pouring from the pouring stopper closely, if its electronics are provided with a transmitter and a receiver which are capable of communicating wirelessly with a PC. This provides the possibility of having full control of the pouring operations, in particular if the pouring stopper is sealed to the bottle.

The invention relates to a pouring stopper for a container, such as a bottle, for the dosing of a predetermined or registerable amount of liquid, said pouring stopper having an area in which the liquid passes, said dosing being based on the pouring stopper being opened or closed on the basis of a magnetizable rod or plate which may be moved by a coil, said pouring stopper being provided with an outlet gasket and optionally an inlet gasket and an air admission valve, said outlet gasket and said optional inlet gasket being opened or closed by the magnetizable rod or plate, which is spring-biased.

The published US Patent Application No. 2005/0263547 describes a pouring stopper of the type defined in the introductory portion of claim 1. In this known pouring stopper, the magnetic force is provided by a coil which affects an armature so that a gasket at both ends of the rod may be caused to assume two positions, where the first position allows filling of liquid from a bottle into a liquid chamber, while the second position is intended to empty the liquid chamber. The magnet arrangement itself, which consists of a coil and a spring-biased armature, is seated in extension of the liquid chamber. The coil itself is seated externally on a bottle holder, which means that the pouring stopper cannot be used for hand pouring.

Accordingly, an object of the invention is to provide a pouring stopper which may be used both in a bottle holder and for hand pouring.

The object of the invention is achieved by a pouring stopper of the type described in the opening paragraph, which is characterized in that the coil and the magnetizable rod or plate are disposed within an area of the pouring stopper.

Hereby, it is possible to use the pouring stopper for hand pouring, and, of course, it may also be placed in a bottle holder.

Further, a very compact pouring stopper is achieved, as the magnetic parts are disposed within the pouring stopper.

Expediently, as stated in claim 2, the stated area is the liquid chamber, or, as stated in claim 3, a section which adjoins a channel in the pouring stopper, which is characterized in a best embodiment, as stated in claim 4, in that steel plates surround a coil, and that a tilting plate, which has a gasket, is spring-biased by a spring, and that the tilting plate has a pivot point at the one steel plate.

To ensure that the dosing of liquid from the pouring stopper is always uniform and accurate, it is advantageous, as stated in claim 5, that a liquid indicator is arranged near the outlet gasket, as it makes it possible to register whether liquid flows out of the pouring stopper during the entire period of time which is predetermined.

When, as stated in claim 6, a liquid indicator is arranged near the inlet gasket, it is possible inter alia to register whether the liquid chamber is filled before pouring is initiated. The volume of the filled liquid chamber will correspond precisely to the desired dosing amount.

When, as stated in claim 7, a liquid indicator is disposed between the inlet gasket and the outlet gasket, it is possible within specific intervals of time to determine the amount of liquid which is present in the liquid chamber.

In connection with the use of the pouring stopper in the metering of particularly time-controlled volumes, it is expedient, as stated in claim 8, that it is equipped with an inclination detector which registers the inclination of the pouring stopper relative to vertical, as the detector may hereby affect an opening mechanism for the flow of liquid during a given period of time, when e.g. the inclination detector has registered an inclination of maximum 20° relative to vertical.

In addition, this has the advantage that if the liquid dispensed by a time-controlled pouring stopper has a certain viscosity, then the dispensed amount of liquid will be constant, since liquid can be dispensed only when the pouring stopper is positioned almost vertically.

Finally, the risk of wrong pouring because of air pockets in the liquid chamber is eliminated.

Particularly in connection with the use of the pouring stopper for hand pouring, it is advantageous, as stated in claim 9, that the liquid chamber is built together with a housing for a battery.

For good sealing of the pouring stopper, it is advantageous, as stated in claim 10, that the magnetizable rod is terminated by the inlet gasket and the outlet gasket at its ends.

When, as stated in claim 11, the pouring stopper is equipped with a functional switch, it is possible to dose various amounts of liquid by means of time control.

Moreover, it is possible to interrupt the energy supply of the stopper from the battery entirely, which is important during the cleaning of it, since all electrical connections may be cut off hereby.

A practical way of ensuring a good operation of the pouring stopper according to the invention is, as stated in claim 12, that the inlet gasket is built together with the air admission valve, and, as stated in claim 13, that the air admission valve is spring-biased.

When, as stated in claim 14, the pouring stopper has an electronics housing, which is built together with the liquid chamber, then options for the control of several functions of the pouring stopper are achieved, if e.g., as stated in claim 15, the electronics housing contains a transmit/receive circuit for the transfer of data between the pouring stopper and a PC.

Hereby, it is moreover possible to achieve full control of the pouring operations, in terms of the time of the pouring operations as well as the amounts which are poured, since all pouring operations may be recorded by the PC. This is attractive in particular if the pouring stopper is sealed to the bottle.

With a view to saving power, it is advantageous, if, as stated in claim 16, a pulsating voltage is applied to the battery for some intervals of time, as, hereby, it is sufficient to apply a constant voltage when the metal rod is moved, it being sufficient to apply a pulsating voltage when the metal rod is to be kept biased against the spring force.

To ensure that the pouring stopper is not removed in an unauthorized manner, it is advantageous, as stated in claim 17, that it is secured and sealed to the bottle.

The invention will now be explained more fully with reference to the drawing, in which

FIGS. 1, 1A show a volume-controlled pouring stopper according to the invention in a first embodiment,

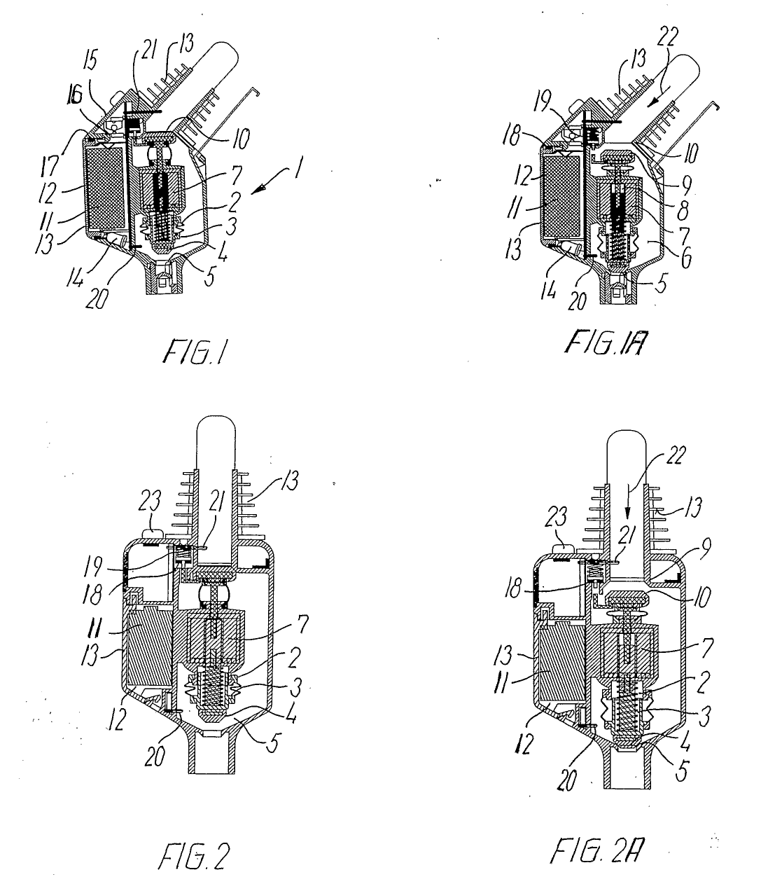

FIGS. 2, 2A show a volume-controlled pouring stopper according to the invention in a second embodiment,

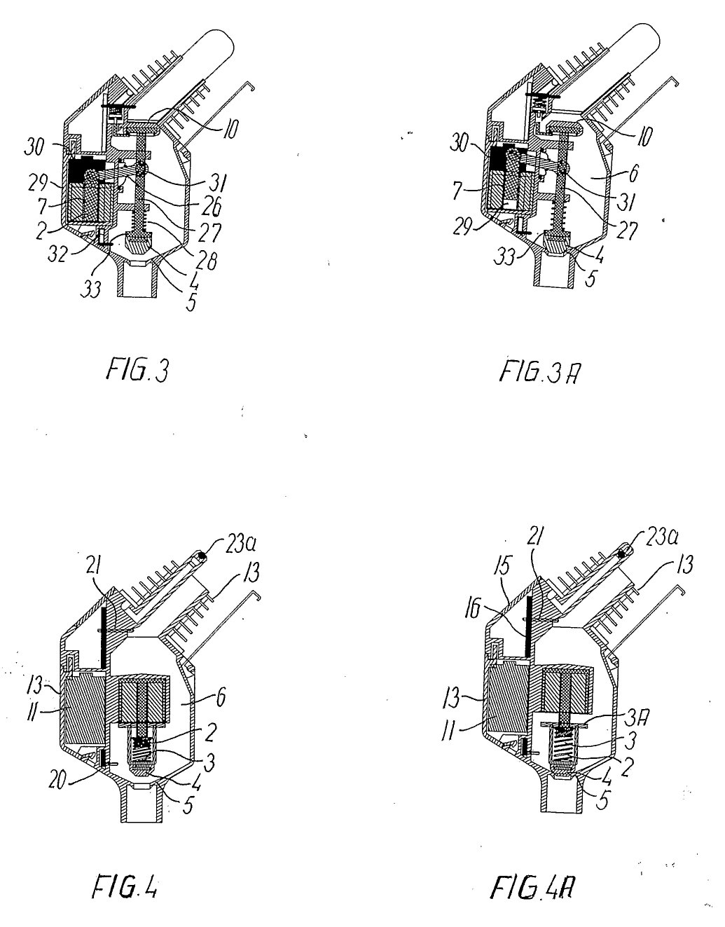

FIGS. 3, 3A show a volume-controlled pouring stopper according to the invention in a third embodiment,

FIGS. 4, 4A show a time-controlled pouring stopper according to the invention in a first embodiment,

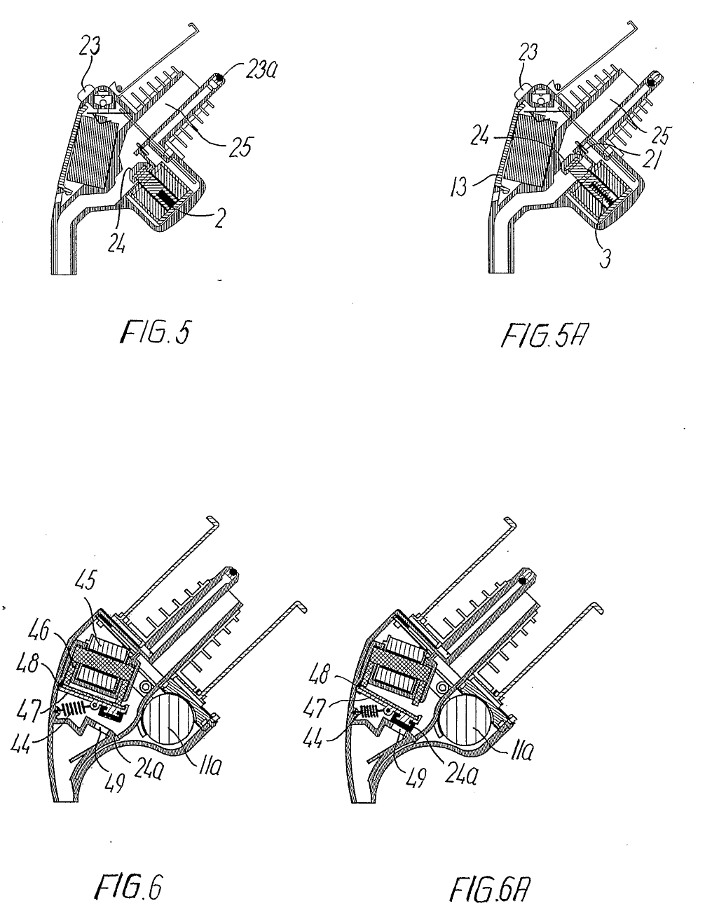

FIGS. 5, 5A show a time-controlled pouring stopper according to the invention in a second embodiment,

FIGS. 6, 6A show a variant of the embodiment of FIGS. 5, 5A,

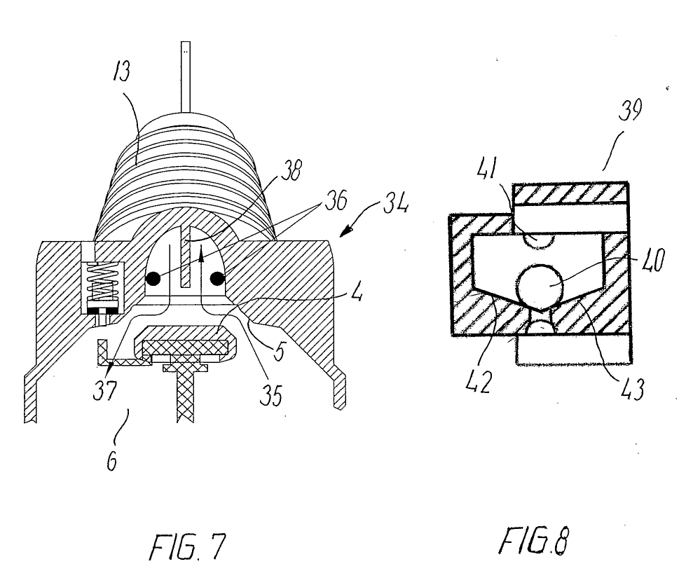

FIG. 7 shows the structure of a liquid indicator for use in a pouring stopper according to the invention, while

FIG. 8 shows an inclination detector for use in connection with the pouring stoppers shown in FIGS. 1, 1A, 2, 2A, 3, 3A, 4, 4A, 5, 5A, 6 and 6A.

In the figures, the reference numerals for the parts which are identical for the various embodiments, are the same.

The numeral 1 designates a pouring stopper according to the invention which is based on volume dosing. The pouring stopper 1 has a liquid chamber 6 which accommodates a magnetizable rod 2, which is biased downwards by a spring 3. At the bottom, the magnetizable rod is terminated by an outlet gasket 4, which may be mounted against a gasket seat 5. Inside the liquid chamber 6, the magnetizable rod is surrounded by a coil 7 which is capable of moving the magnetizable rod in a space 8, cf. the following.

At its upper end, the magnetizable rod 2 is terminated by an inlet gasket 9, which may be mounted against a gasket seat 10. An air rod 17 is arranged laterally to the inlet gasket, said air rod being adapted to affect an air valve 18 having a diaphragm, which is biased by a spring 19.

The pouring stopper has an additional housing 12 with a lid 13, made of transparent acrylic, which in this case accommodates a battery 11. However, nothing prevents the provision of more than one battery in the housing 12.

The housing 12 may also contain various diodes, as shown at 14, which display various operational states, e.g. that a bottle connected with the pouring stopper is empty.

A liquid indicator 20 is arranged at the bottom of the liquid chamber 6 in connection with the printed circuit board.

Further, the pouring stopper 1 has a bottle gasket 13 which is intended to be inserted into a bottle neck (not shown).

Finally, a further liquid indicator 21 is arranged in the vicinity of the air valve 18, likewise in connection with the printed circuit board 16.

The pouring stopper operates in the following manner:

With the inlet gasket 9, the outlet gasket 4 and the air valve 18 in the position shown in FIG. 1A, liquid from a bottle (not shown) will be able to flow into the chamber 6 in the direction of the arrow 22 and fill the chamber, which is dimensioned to hold a predetermined volume.

When both liquid indicators 20, 21 have detected that liquid is present in the liquid chamber 6, the inlet valve 9, the outlet valve 4 and the air valve 18 change their position to the position shown in FIG. 1, where the inlet valve 9 closes, while the outlet valve 4 and the air valve 18 open, as the battery 11, by means of a signal from the printed circuit board 16, applies a voltage which moves the magnetizable rod 2 into the space 8 inside the coil 7.

It should be noted that other ways of registering liquid in the chamber than the use of liquid indicators may be used. For instance, a floating member may be arranged inside the liquid chamber, registering when the liquid level inside the liquid chamber has reached a certain height.

At the same time, the transmission/reception equipment on the printed circuit board will be able to transfer data to a PC (not shown), which inter alia records the time of the dispensing of liquid, which type of liquid is involved, the amount of liquid, and in the event that several pouring stoppers are provided, which of these is in use.

FIGS. 2 and 2A show an embodiment which is modified relative to the embodiment of FIGS. 1 and 1A only in that, in this embodiment, the bottle is completely upright when dispensing, whereas the bottle of FIGS. 1 and 1A will have an angle of 45°. It is ensured hereby that the pouring stopper may be used in a bottle holder, where the bottle holder is completely passive and does not have any parts which are incorporated in the pouring process proper. Therefore, the same reference numerals are used for the parts which are identical with those shown in FIGS. 1 and 1A.

At the top, a switch is arranged, which may e.g. be a functional switch 23 consisting of magnets and read relays, where e.g. combinations of a plurality of magnets and a plurality of read relays, e.g. two of each, may represent desired functions of the pouring stopper. These functions may be completely disconnected pouring stopper, various metering sizes, setting with respect to whether the pouring stopper is to operate as hand pouring or be wall-mounted, etc.

The embodiment of FIG. 3 and FIG. 3A differs from the embodiments of FIGS. 1, 1A, 2, 2A in that the magnetizable rod 2 is placed in a side chamber 29 and is connected with a movable rod 26, which is connected with another movable rod 27, at whose ends the inlet gasket 10 and the outlet gasket 4, respectively, are disposed. At its one end, the rod 26 is connected with the magnetizable rod 2 at a pivot point 30, while its other end is connected with the rod 27 at a pivot point 31.

Further, the rod 27 is biased by a spring 28 which is positioned between two plate parts 32, 33, where the one plate part 32 is secured to the side chamber 29, while the other plate part 33 is secured to the movable rod 27.

The embodiment shown in FIGS. 3, 3A operates in the following manner.

From the position of the rod 27 shown in FIG. 3A with the outlet gasket 4 closed, the liquid chamber 6 is filled.

When the chamber 26 has been filled, the magnetizable rod 2 is activated by the coil 7, whereby the rod 27 assumes the position shown in FIG. 3, where the inlet gasket 10 closes, while the outlet gasket 4 opens, which is basically the same patterns of movement as explained in connection with FIGS. 1, 1A, 2 and 2A.

Reference is now made to FIGS. 4, 4A, which show an embodiment based on a liquid dosing which is time-based. Many of the parts incorporated in this embodiment are the same as those which are incorporated in the embodiments in FIGS. 1, 1A, 2, 2A, 3, 3A, and are therefore given the same reference numerals.

This embodiment only includes an outlet gasket 4 and a separate air valve 23a of a known type, but no inlet valve. The inclination detector (not shown) on the printed circuit board 16 is important, as it has the function of just allowing opening of the outlet valve 4 when the liquid chamber has assumed a position relative to vertical which must not differ by more than e.g. 20°, the reason being that the amount of liquid capable of passing the outlet gasket per time unit is smaller if the liquid chamber assumes a more horizontal position, which is important in particular when dosing liquids having a relatively high viscosity content.

The pouring stopper of FIGS. 4 and 4A operates in the following manner:

From the position of the outlet gasket shown in FIG. 4A, a signal is applied to open it, if the inclination detector has detected that the outlet chamber has an angle relative to vertical which is within predetermined limits, e.g. 20°. In addition, the liquid detector 21 must have detected that liquid is present in the entire chamber.

When the conditions are satisfied, the outlet gasket 4 is opened for a predetermined period of time, and when the period of time has elapsed, the outlet gasket closes, following which a new dosing may be implemented.

It should moreover be noted that it does not necessarily have to be the rod which is moved as a consequence of the magnetism of the coil, but, on the other hand, a disc 3 which is attracted and repelled by a spring.

It should be noted that the time-controlled dosing provides the rapid option of dosing various amounts from e.g. 2 cl to emptying of a completely filled bottle, since just the dosing period of time is to be set. In practice, a switch may be provided, where the various positions of the switch activate a desired dosing period of time.

The embodiment of FIGS. 5 and 5A differs from the one shown in FIGS. 4 and 4A in that it does not have a liquid chamber, but the outlet gasket 24 is moved between a position in which liquid passes in a channel, see FIG. 5, and a position, see FIG. 5A, in which the channel is closed by the outlet gasket 24. In this embodiment there is also an air valve 23a. In this structure, the magnetic parts of the outlet valve are not surrounded by liquid.

Further, this embodiment just includes a liquid indicator 21 which registers partly whether the bottle is empty, and partly when the bottle becomes empty in connection with a dispensing operation, so that any residual proportion of a fixed dispensing amount may be dispensed subsequently from another bottle where the pouring stopper is mounted.

Moreover, this embodiment is characterized by being able to perform many functions while maintaining physically small dimensions, which imparts a discrete and elegant appearance to the pouring stopper.

The embodiment of FIGS. 6, 6A differs from the embodiment of FIGS. 5, 5A in that a battery 11a applies a voltage through a coil 45 having a fixed iron core. The coil is equipped with steel plates 46 at each end. The ends of the steel plates are present inside the liquid chamber in a way which allows no liquid access from the liquid chamber to the dry chamber.

A tilting plate 47 is arranged inside the liquid chamber, which is capable of tilting around a pivot point 48. The tilting plate 47 is spring-loaded by a spring 44. A gasket 24a, which can open and close an outlet 49, is mounted at one end of the tilting plate 47.

When voltage is applied via the battery 11a, the tilting plate 47 will assume the position shown in FIG. 6, whereby liquid may flow through the outlet 49. When the voltage is interrupted, the spring 44 will pull the tilting plate 47 to the position shown in FIG. 6A, whereby the gasket 24a will close the outlet 49.

As will be appreciated, all the above-mentioned embodiments of the pouring dispenser may be used both as being handheld and mounted on a wall or the like.

It is noted in this connection that the handheld, volume-controlled embodiments with electronic control are particularly unique in that they have a chamber which has a size corresponding to the dosing amount.

It is shown in FIG. 7 how a liquid indicator, which is generally designated 34, near an inlet gasket may be constructed. A liquid indicator 36 is arranged on each side of a partition wall 38. When a bottle (not shown) is placed on the bottle gasket 13, liquid flows into the liquid chamber 6 in the direction of the arrow 37, while air is conveyed back into the bottle in the direction of the arrow 35.

When the liquid chamber 6 is filled, both liquid indicators get into contact with liquid, following which the gasket 4 is caused to close against the gasket seat 5.

FIG. 8 shows an example of how an inclination detector, which is generally designated 39, may be constructed. It is formed by a ball 40 which blocks a path of light between a photodiode transmitter 44 and a photodiode receiver 41. When the inclination detector is moved relative to vertical, the ball will slide up the faces 42 or 43, thereby establishing a path of light between the photodiode transmitter 44 and the photodiode receiver 41, indicating that the inclination detector is not vertical. The inclination, which is detected, may be set merely by changing the inclination of the faces 42 and 43.

1. A pouring stopper for a container, such as a bottle, for the dosing of a predetermined or registerable amount of liquid, said pouring stopper having an area in which the liquid passes, said dosing being based on the pouring stopper being opened and closed on the basis of a magnetizable rod or plate which may be moved by a coil, said pouring stopper being provided with an outlet gasket and optionally an inlet gasket and an air admission valve, said outlet gasket and said optional inlet gasket being opened or closed by the magnetizable rod or plate, which is spring-biased,
wherein the coil and the magnetizable rod or plate are disposed within an area of the pouring stopper.

2. A pouring stopper according to claim 1, wherein the area is the liquid chamber.

3. A pouring stopper according to claim 1, wherein the area is a section which adjoins a channel in the pouring stopper.

4. A pouring stopper according to claim 3, wherein steel plates (46) surround a coil (45), a tilting plate (47), which has a gasket (49), is spring-biased by a spring (44), and the tilting plate has a pivot point at the one steel plate.

5. A pouring stopper according to claim 1, wherein a liquid indicator is arranged near the outlet gasket.

6. A pouring stopper according to claim 1, wherein a liquid indicator is disposed near the inlet gasket.

7. A pouring stopper according to claim 1, wherein a liquid indicator is disposed between the inlet gasket and the outlet gasket.

8. A pouring stopper according to claim 1, wherein it is equipped with an inclination detector which registers the inclination of the pouring stopper relative to vertical.

9. A pouring stopper according to claim 1, wherein the liquid chamber is built together with a housing for a battery.

10. A pouring stopper according to claim 1, wherein the magnetizable rod is terminated by the inlet gasket and the outlet gasket at its ends.

11. A pouring stopper according to claim 1, wherein it is equipped with a functional switch.

12. A pouring stopper according to claim 1, wherein the inlet gasket is built together with the air admission valve.

13. A pouring stopper according to claim 1, wherein the air admission valve is spring-biased.

14. A pouring stopper according to claim 1, wherein it has an electronics housing which is built together with the liquid chamber.

15. A pouring stopper according to claim 14, wherein the electronics housing contains a transmit/receive circuit for the transfer of data between the pouring stopper and a PC.

16. A pouring stopper according to claim 1, wherein a pulsating voltage is applied to a battery during some periods of time.

17. A pouring stopper according to claims 1, wherein it is secured and sealed to the bottle.
